(19) United States
(12) Patent Application Publication
(10) Pub. No.: US 2006/0101141 A1
(43) Pub. Date: May 11, 2006

(54) Expanded monitoring for a plurality of processes via agents

(76) Inventor: Emilian Ertel, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 11/261,992

(22) Filed: Oct. 27, 2005

(30) Foreign Application Priority Data
Oct. 27, 2004 (DE) 10 2004 052 249.9

(51) Int. Cl. G06F 15/173

(52) U.S. Cl. 709/224

(57) ABSTRACT

The invention concerns a method, a device and a system for monitoring for a plurality of processes via a central monitoring unit. The processes respectively comprise an agent that is assigned to receive signals from the process, to analyze these signals and—in the event that a predeterminable communication condition is fulfilled—to send a message to the monitoring unit. The message is thereby designed such that the monitoring unit can automatically detect whether the process to be supervised is still running, has been successfully terminated, or has been aborted.

### BACKGROUND

The invention concerns the supervision or monitoring of a plurality of processes, particularly medically-related processes, that communicate with one another via a network, whereby the monitoring is executed via a central monitoring unit.

It is the goal of a central monitoring to observe various processes that can be installed in a distributed fashion, for example, installed in a distributed manner over a plurality of hospital departments. It has previously been typical that a central monitoring unit queries a state of the respective process to be supervised, in particular in processes that are in the field of radiology.

However, in known systems, only two process states can be detected with this query, namely “process is started” and “process was stopped”. FIG. 1 shows that only the two states cited in the preceding (“started” and “stopped”) can be processed as a status. Previous monitoring systems used in the prior art, in particular in the field of radiology, can thus not detect the cause of a process abort or of a general incorrect process behavior.

Known systems are disadvantageous in that these monitoring systems only exhibit a limited information possibility and moreover exhibit very long service times, since a service technician must be called in in the event of a process abort.

Since a process abort cannot be automatically detected in previous systems, it is also not possible to determine the causes for this process abort and to collect information specific to this. An analysis of the process abort does not ensue.

The respective process to be monitored communicates with the central monitoring unit via a network. Since, in the case of a process abort, no further specific information is collected on the part of the process, in known systems, it is therefore necessary in a disadvantageous manner that, if applicable, very many data sets that can possibly allow conclusions about an error cause must be transferred from the process to the monitoring unit. This non-specific but possibly relevant information moreover leads to a very significant network load.

Furthermore, it was previously necessary to store and to administer this plurality of non-specific data sets on the monitoring unit. Since nearly always only a small segment of these data sets is relevant for the identification of possible process abort causes, in known systems, irrelevant data sets would nevertheless have to be administered, which additionally limits the available capacity of the monitoring unit.

### SUMMARY

An object of the present invention therefore is to show a way with which an expanded and central monitoring of processes is possible and in which the data volume to be administered on the monitoring unit and the data exchange between the process to be monitored and the monitoring unit can be reduced.

This object, in an exemplary tomography imaging system, is inventively achieved via a method for monitoring or a plurality of processes (particularly in medically-related processes in the field of radiology) that communicate via a network with a central monitoring unit, whereby a process to be supervised is respectively provided with at least one agent, and whereby the agent is assigned to receive signals from the process, to analyze the signals so received and, if applicable (namely in the event that a predeterminable communication condition is fulfilled) to send a message to the monitoring unit, whereby the message is designed such that the monitoring unit can automatically detect whether the process has been terminated or not. Additionally, this object is achieved by a device and system with components configured to implement the method according to the embodiments described below.

The processes to be supervised are preferably radiological processes that can be executed in hardware and/or software.

In radiological data technology, it is very frequently necessary that large data volumes must be exchanged between individual processes. In order to not too severely stress the underlying network with regard to its load due to the monitoring object, in monitoring systems in the field of radiology, it is therefore particularly important to keep the data volumes to be exchanged optimally low.

A particular advantage of the present invention is therefore that only the data relevant for the respective supervision are transferred, such that the network can be unloaded.

In a preferred embodiment, the monitoring unit is designed as a central instance that executes the monitoring of the individual processes on a hierarchically higher-situated level and thus can also operate across processes. In an advantageous manner, it is therewith also possible to detect non-process-specific states, for example, such states that are network-based or have been caused by another system.

According to various embodiments of the invention, the monitoring task is divided up into two components: on the one hand, it is executed by the agent associated with the respective process and on the other hand it is executed by the central monitoring unit itself. The agent is situated in the data exchange with the process to be supervised and receives signals from this, particularly signals that are relevant for the monitoring of the process.

In a preferred embodiment, these signals are not immediately sent to the monitoring unit; rather, these signals are subjected to an analysis procedure and are only indirectly transferred to the monitoring unit in the form of a message. This advantageously permits only information with regard to the monitoring that is relevant for the monitoring unit to be exchanged in order to unload the network.

However, in an alternative embodiment of the invention, it is likewise possible to directly send signals received by the agent to the monitoring unit without further processing steps. This has the advantage that the agents at the process must be designed in a less complex manner. However, it is therewith necessary that the central monitoring unit takes on further monitoring tasks and in particular executes an analysis of the transmitted signals.

The message transmitted by the agents to the monitoring unit is preferably designed such that it enables a further-reaching analysis and diagnosis of possible error causes. In a preferred embodiment, the message therefore comprises still further data (in particular, a termination cause) in addition to the relevant process states. Given a process abort, still further windows can also come up on a user interface, in which windows with messages such as “out of memory” or “Null Pointer Exception” are displayed, for example. After the transmission of the message to the monitoring unit, it is possible that the monitoring unit automatically detects whether the process to be supervised is still running, has concluded in the meantime, or has been terminated.

These three state variables are sent to the monitoring unit.

However, it is also possible to set that the agent only sends a message to the monitoring unit in the event that a process has been terminated.

In principle, the sending of the message ensues when a predetermined communication condition is fulfilled. This communication condition can be inventively pre-set. The inventive method can therewith be dynamically adapted to the current and respective requirements and thus exhibits an increased degree of flexibility in an advantageous manner. The communication condition can, for example, be a temporal condition, such that the transmission of the message is initiated after a predeterminable time interval.

Moreover, the communication condition can consist of a Boolean function and thus determine that a transmission of the message only ensues when the process has been aborted and/or interrupted and/or successfully terminated. Furthermore, further conditions that depend on other parameters (for example, the network load) can be integrated into the communication condition. The inventive system can therewith be very flexibly adapted to varying general conditions.

In a preferred embodiment of the invention, the signals of the process that are received by the agent are analyzed by the agent. This analysis primarily serves the purpose of establishing whether the process to be supervised is still running, has stopped in the meantime or has been terminated. However, it is also possible to incorporate further processing and/or diagnostic steps into this analysis. For example, it is thus possible to examine after which time interval the process to be supervised has been terminated. The analysis ensues in a preferred manner on the basis of a pattern comparison or a pattern matching. The received signals and the pattern with which these signals are compared can be application-specific, network-specific and/or system-specific. In a simple embodiment, the pattern comparison comprises only three patterns: 1. process is running (running), 2. process has been successfully terminated (stopped) and 3. process aborted (failed).

In the event that the process to be supervised has been aborted (failed case), the agent preferably sends additional data to the monitoring unit that enable the identification of a cause of the process abort. The identification of the process abort and/or an error search ensues automatically. The additional data are typically provided in the form of a link to a “log file”. Moreover, an interface is provided with whose help the user can navigate in the associated log file in order to manually search for a possible cause of the process abort.

In a preferred embodiment, the agent is the active part with regard to the data exchange, i.e., with regard to the transmission and reception of data, signals, or messages. In a preferred embodiment, the agent is thus designed such that it requests the signals from the process and receives them. Moreover, it initiates the transmission of the message to the monitoring unit. A significant part of the response range with regard to the data exchange is therewith incumbent on the agent. In contrast to this, the monitoring unit is the passive part and is designed such that it is designated for reception of the messages of the agent.

In a preferred embodiment, the method comprises a generation of an application interface that is adapted to the specific application case. The application interface is automatically generated and provided on the monitoring unit. Only the relevant information appears on this application interface. The interface can therewith be designed significantly more application-friendly, in that (for example) possible error causes are shown only in the case of a process abort and do not appear at all when the process could have been terminated successfully.

An advantageous embodiment, however, is designed such that the entire interface of the process to be supervised is not shown on the interface of the monitoring unit; rather only the information relevant for the respective monitoring are shown on the surface of the monitoring unit. This prevents requiring that unnecessarily large data volumes be transferred between the agents and the monitoring unit, which would then be necessary in the event that the entire user interface of the application process to be supervised should be shown.

In contrast to this, it is inventively provided that the agent and/or the monitoring unit conducts further processing steps, such that it is possible to show only specific information, for example, a specific entry in a log file that is to be assessed as an indication of the cause of a fault abort. The complete integration of the user interface of the process to be supervised is therefore not necessary and need not be provided.

A started process is typically ended either via a successful termination or via a process abort. However, it is also possible that a process is manually stopped, i.e., at the request of the user. In this case, a monitoring of the process is superfluous. In order to cover these cases, with the inventive method it is advantageously possible to exclude a process from monitoring by, e.g. simply pressing a key or clicking a mouse. A communication to the monitoring unit of aborted processes that have been intentionally terminated can therewith be prevented, such that less data must be administered in the monitoring unit.

As a rule, the processes to be supervised are components of a complex application or method. There are very important and less important processes for the function of the overall method. This means that the processes can be classified with regard to their relevance for the overall process. For example, if a process abort of a less relevant process is now detected, this can be less substantial for the overall system than when a process abort of a very relevant process has been determined.

An advantageous embodiment therefore additionally comprises a further processing mechanism in the monitoring unit. This processing mechanism is designed for the further processing of the detected monitoring processes. This means that all process aborts are detected and respectively placed in relation to one another. For example, a process abort of a subordinate sub-process can be detected as a possible danger warning of a possible pending process abort of one or more superordinate processes. Advantageously, it is possible to already detect possible process aborts of superordinate systems in advance and to warn before these situations occur. This can inventively be achieved in that the monitoring unit is fashioned as a central instance in which monitoring cycles of various processes are detected and set in relation to one another.

In the event that the monitoring indicates a process abort, the inventive method may comprise a parsing of a log file associated with the process. This enables it to identify possible causes for the process abort and to add them as such to the message that is sent to the monitoring unit.

In an advantageous development of the invention, the method is preferably designed such that the receipt of the signals on the part of the agent, the analysis of these received signals and/or the transmission of the message on the part of the agent to the monitoring unit ensues automatically. Errors of the monitoring method can therewith be prevented via error conditions on the part of the personnel.

In a preferred embodiment, the inventive system comprises the agent that is arranged on the side of the process and the central monitoring unit. The agent is moreover equipped with a reception module and a with a communication module. In an advantageous development of the inventive system, this additionally comprises an analysis module that is fashioned for analysis of the received signals. It is possible to provide the analysis module on the agent or centrally on the monitoring unit. Moreover, it is possible to fashion the analysis module in a distributed manner, such that it is provided both on the agent and on the monitoring unit.

The inventive embodiments of the method described in the preceding can also be fashioned as a computer program product, with a medium readable by a computer and with a computer program and associated program code, whereby the computer is initialized after loading of the computer program for implementation of the inventive method described above.

An alternative object solution is provided by a storage medium that is designated for storage of the computer-implemented method described in the preceding and can be read by a computer.

Additional advantageous embodiments are described in more detail below.

### DESCRIPTION OF THE DRAWINGS

In the following detailed Figure description, the drawings of the exemplary embodiments to be understood are discussed without restriction and with their features and further advantages.

FIG. 1 is a screen representation according to a known system from the prior art;

FIG. 2 is a block diagram illustrating an overview-like representation of significant components according to a preferred embodiment of the invention;

FIG. 3 is a screen representation according to a preferred embodiment of the invention,

FIG. 4 is a further screen representation according to a preferred embodiment of the invention; and

FIG. 5 is a screen representation in connection with an indicated process workflow text according to an embodiment of the invention.

### DETAILED DESCRIPTION OF THE PREFERRED EMBODIMENTS

An embodiment of the inventive method is designed for monitoring a plurality of processes P, whereby the number of the processes P to be supervised is arbitrary. The processes P are equipped with an agent A that is preferably fashioned in the form of a software module and is locally executed on the process P or the respective application to be supervised. Furthermore, a monitoring unit 10 that communicates with the agent A via a network 12 is provided as a central instance. The processes P are typically part of a comprehensive system and must interact amongst one another. The communication of the processes P then also ensues over the network 12.

Furthermore, the central monitoring unit 10 is equipped with a user interface 14 via which a user can control and/or observe the monitoring of the processes P.

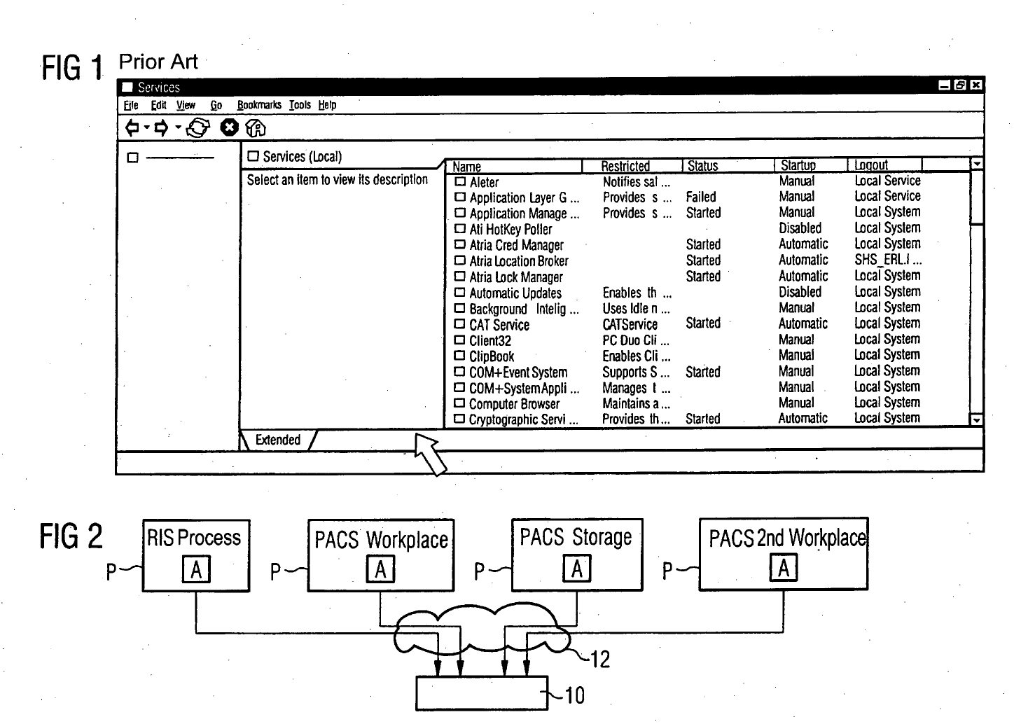

A display of a system according to the prior art is shown in FIG. 1. In known systems, it was previously in principle only possible to process two system states of processes P, namely: 1. “process is started” and 2. “process is stopped”.

In a disadvantageous manner, it was previously not possible that the monitoring system enabled a conclusion about whether the component or the process P was intentionally or unintentionally stopped and/or whether the component had failed and/or why an error behavior had occurred.

With the inventive procedure, it is possible to expand this limited information possibility of systems according to the prior art, such that at least one further state can likewise be detected and processed, namely “process is aborted”. In this case, further information can be requested in order to implement a detailed error analysis and diagnosis. In FIG. 1, the screen printout therefore exhibits only the status descriptions “Started” and “Stopped”.

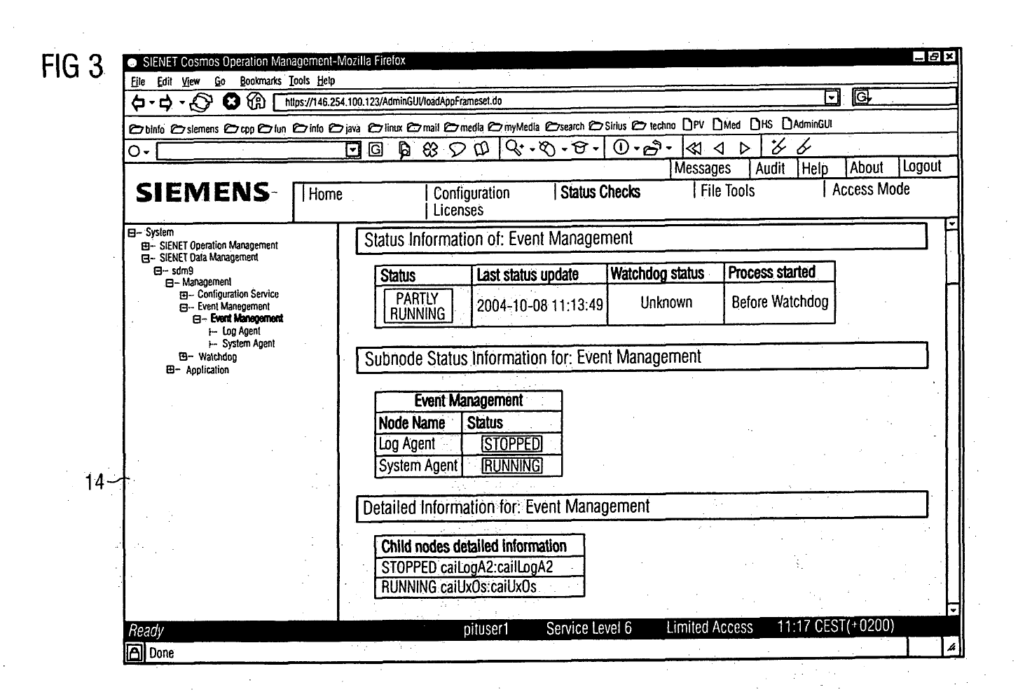

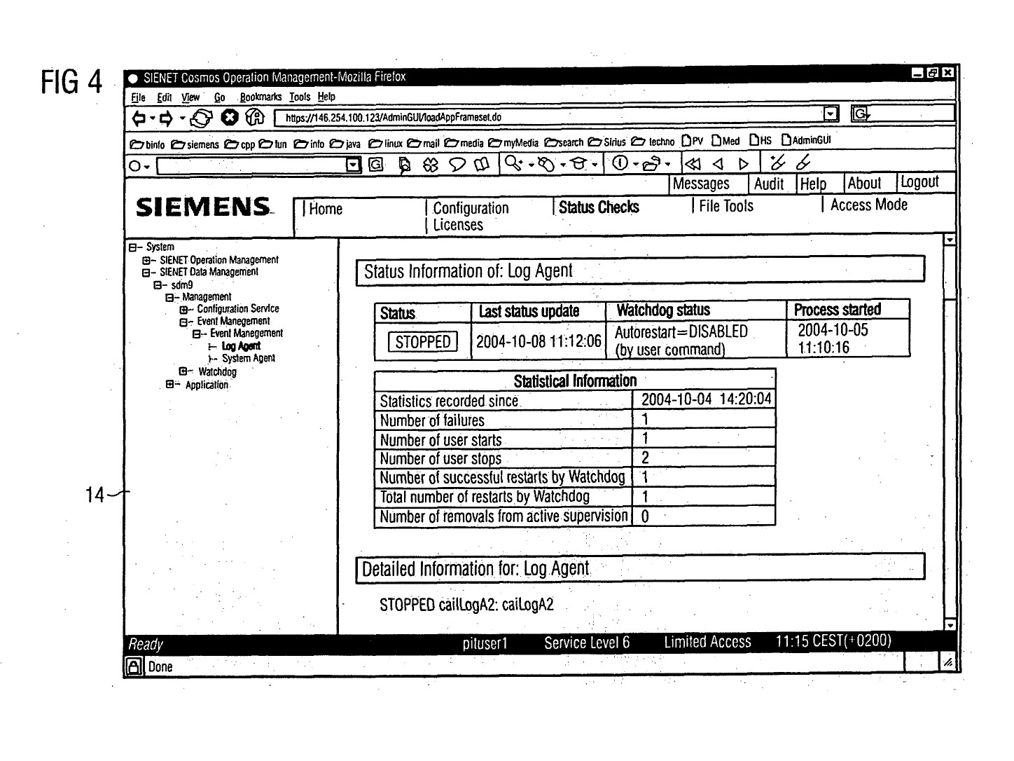

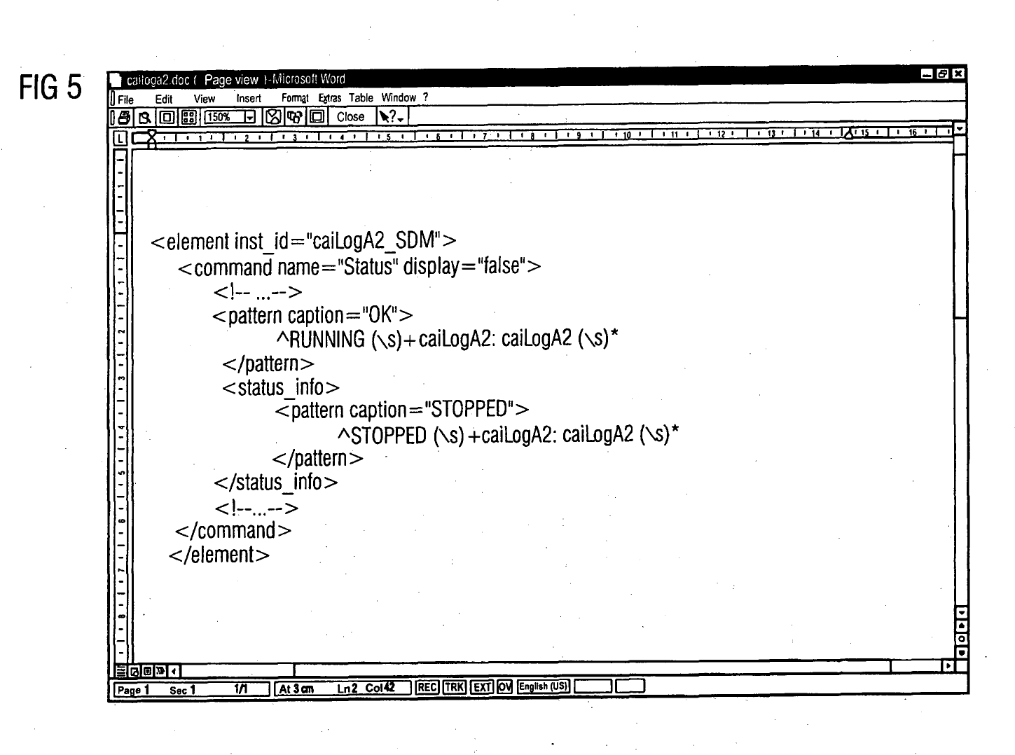

In contrast to this, the user interface 14 of the inventive monitoring unit 10 comprises the additional status “Failed” in addition to the states “Started”, “Stopped”. This is shown in FIGS. 3 and 4.

In FIG. 4 it is shown that a statistical analysis of all monitoring cycles ensues, in particular that the number of the “Failed” cases is detected and displayed. In the event that the monitoring unit 10 signals a process abort, it is provided in a preferred embodiment to provide further information. The further information can preferably exist in a link or in a pointer to the appropriate point in a log file.

In the following, significant elements of the inventive solution are described in connection with FIG. 2.

The monitoring unit 10 is fashioned as a central instance that serves for supervision or for monitoring of a plurality of processes P. In a preferred embodiment, the processes P are designed as components of a radiological system. They are thereby preferably radiology information system (RIS) processes and/or picture archiving communication system (PACS) systems and systems associated with the latter, such as a storage system and/or other archiving systems. All processes P to be supervised are designed with an agent A. The agent is designated to receive and, if applicable, to process signals from the process P to be supervised. In the event that the processed signals fulfill a predetermined communication condition, a message is sent from the agent A to the monitoring unit 10. The message is designed such that, after the receipt of the message, the monitoring unit 10 can automatically detect whether the respective process to be supervised has been aborted or not, or whether, for example, it has been successfully terminated or is still running.

The monitoring unit 10 communicates with the agent A over the network 12.

In a preferred embodiment, an agent A is respectively provided with a reception module that serves to receive the signals from the process P that are relevant for the monitoring. The agent A additionally comprises a communication module that serves to send the message from the agent A to the monitoring unit 10. The content of the message can be at least three process states, namely: 1. “process running”, 2. “process successfully terminated” and 3. “process aborted”.

In an advantageous development of the invention, it is possible that the agent additionally comprises an analysis module that is designated to analysis signals received from the process P. For example, here specific filter settings can be made dependent on the respective application or on the respective process P. Moreover, here it is also possible to implement a pattern matching (a pattern comparison) in which it is examined whether the received signals correspond to a predeterminable pattern.

In connection with FIGS. 3 and 4, the following explains how status information, detailed monitoring information, and statistical information about all monitoring processes or about a selection of monitoring processes are shown on the user interface 14.

In the event that the value of the variable “status” coincides with a predeterminable value, thus with a pattern (for example, “stopped” or “failed”), it can be preset that the agent A initiates the transmission of an associated message to the monitoring unit 10 (“detailed information for: log agent” in FIG. 4).

The user interface 14 of the monitoring unit 10 can be flexibly and adaptively changed to current requirements of the process P to be supervised. This has the advantage that the user must only be confronted with relevant information with regard to the monitoring event and does not receive unnecessary detail data on the display.

Due to the design of the monitoring unit 10 as a central instance in the monitoring system, it is possible to also account for interdependencies between the processes P to be supervised. For example, it is possible that specific processes P are more important than others for the function of the overall system. This means that a failure of a less relevant process P should send a message to the monitoring unit 10 that exhibits a lesser importance or relevance than, for example, a message that corresponds to a more central, much more significant process P having been aborted. It is therewith possible to scale the messages and to effect a ranking with regard to the relevance of received messages.

Furthermore, it is possible to change the communication condition. For example, cases can therewith be flexibly reacted to in which it makes no sense to send a message to the monitoring unit 10 (in the event that a less relevant process P has failed for only a very small time interval and was subsequently started again without the possibility of establishing a consequence of the process abort). In contrast to this, in other very critical applications it is not necessary to define the communication condition such that a message is always sent to the monitoring unit 10 in every case in the event that only one of the processes P exhibits an abort.

Moreover, according to an embodiment of the invention it can be set to exclude specific processes P of an overall system from the monitoring. For example, if an overall system comprises the processes P₁, P₂, . . . , Pₙ and if, for example, the process P₃ is manually shut down and subsequently reactivated, this should have no effect on the monitoring of the overall system. In this case, before the shutdown of the process P₃ it is therefore possible to exclude the process P₃ from the monitoring, such that the monitoring of the overall system can be concluded as successful in spite of an abort of the process P₃.

Due to the design of the agent A at the process P as an independent processing unit, in particular with an analysis module, it is possible to reduce the data volume to be transferred between the agent A and the monitoring unit 10. It is henceforth no longer necessary to transfer complete log files and to administer them on the monitoring unit 10; rather, only the data sets that have been detected as relevant by the agent A are transferred. With this it can furthermore be prevented that very large information blocks, complete documents and/or a complete screen content must be translated in an error search. The network 12 can thus be noticeably unloaded.

Moreover, the monitoring unit 10 operates according to a top-down approach, such that only the roughest process state is shown in a first representation step. In this first super test program, it is thus shown on the screen interface 14 of the monitoring unit 10 whether the respective process to be supervised is still running, has been successfully terminated or has been aborted. In the case of a process abort, further detail information can then be shown in a second method step. If the process P to be supervised is thus, for example, of lesser importance for the user at the current point in time, he can “skip” the detail information, such that it does not even appear on the interface. Alternatively, he can, for example, initiate the display of detail information via activation of the mouse. This detail information can, for example, be a specific data set in the associated log file.

Since the inventive solution is based on a central monitoring unit 10, the monitoring messages can also be shown via a generic interface.

In a preferred embodiment, the inventive processing is based on three process states: “Started”, “Stopped”, “Failed”. However, in an alternative embodiment it is also possible to provide and to process further process states here. For example, the process status “Failed” can be divided up further dependent on determined time intervals.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for monitoring for a plurality of processes that communicate over a network, with a central monitoring unit, comprising:
providing a process with at least one agent;
receiving, by the agent, signals from the process,
analyzing the received signals; and
sending a message to the monitoring unit if a predeterminable communication condition is fulfilled, wherein the message is designed such that the monitoring unit can automatically detect whether the process has been aborted.

2. The method according to claim 1, further comprising:
determining a cause for an abort of the process from the message sent to the monitoring unit; and
showing the cause on a user interface if it is determined that the message should be shown.

3. The method according to claim 1, wherein analyzing the received signals comprises:
determining whether the received signals indicate that the process is still running, has been stopped or has been aborted.

4. The method according to claim 1, further comprising:
providing status data in the message about the process identifying the following processes states: process has been started, process was stopped, and process was aborted.

5. The method according to claim 1, further comprising:
providing, in the message, data that represents a link to a log file the process has been aborted.

6. The method according to claim 1, further comprising:
generating an interface on the monitoring unit that is adapted to an existing monitoring and that shows on the monitoring unit only data predetermined to be relevant for the process to be supervised.

7. The method according to claim 1, wherein the agent locally resides on an application computer.

8. The method according to claim 1, analyzing the received signals comprises:
parsing an associated log file if the process has been aborted.

9. The method according claim 1, wherein at least one of the receiving signals, analyzing the received signals, and sending a message is performed automatically.

10. A device for monitoring for a plurality of processes that communicate over a network, comprising:
a central monitoring unit;
a process; and
an agent that is associated with the process, the agent comprising:
a reception module that receives signals from the process;
an analysis module that analyzes the received signals; and
a communication module that sends a message to the monitoring unit if a predeterminable communication condition is fulfilled, the message being designed such that the monitoring unit can automatically detect whether the process has been aborted.

11. The device according to claim 10, wherein the message sent to the monitoring unit comprises information related to a cause determination for an abort of the process.

12. The device according to claim 10, wherein the analysis module analyzes the signals of the process that are received by the agent, and determines from the signals whether the process is still running, has been stopped or has been aborted.

13. The device according to claim 10, wherein the message comprises status data about the process that characterize the following processes states: process has been started, process was stopped, and process was aborted.

14. The device according to claim 10, wherein the message comprises a link to a log file if the process has been aborted.

15. The device according to claim 10, further comprising:
an automatically generated interface on the monitoring unit that is adapted to an existing monitoring and that shows on the monitoring unit only data predetermined to be relevant for the process to be supervised.

16. The device according to claim 10, wherein the agent locally resides on an application computer.

17. The device according to claim 10, further comprising:
a parser that parses a log file associated with the process with regard to the signals of the process that were received by the agent if the process has been aborted.

18. The device according claim 10 wherein at least one of the receipt of the signals on the part of the agent, the analysis of the signals, and the transmission of the message to the monitoring unit on the part of the agent ensues automatically.

19. A system arrangement for monitoring for a plurality of processes that communicate over a network, comprising:
a central monitoring unit;
a process; and
an agent that is associated with the process, the agent comprising:
a reception module that receives signals from the process; and
a communication module that sends a message to the monitoring unit if a predeterminable communication condition is fulfilled, the message being designed such that the monitoring unit can automatically detect whether the process has been aborted.

20. A system arrangement according to claim 19, the system further comprising:
an analysis module that analyzes the signals received from the process.
